(19) United States
(12) Patent Application Publication
(10) Pub. No.: US 2025/0114820 A1
(43) Pub. Date: Apr. 10, 2025

(54) LAYERED FILM AND PRODUCTION METHOD THEREFOR

(71) Applicant: TOYOBO CO., LTD., Osaka (JP)

(72) Inventors: Miyuki HAYASHI, Otsu (JP); Kento YOSHINO, Otsu (JP); Hideki TANAKA, Otsu (JP)

(73) Assignee: TOYOBO CO., LTD., Osaka (JP)

(21) Appl. No.: 18/834,484

(22) PCT Filed: Jan. 6, 2023
(86) PCT No.: PCT/JP2023/000209

§ 371 Date: Jul. 30, 2024

(30) Foreign Application Priority Data
Feb. 1, 2022 (JP) 2022-014334

(51) Int. Cl. B05D 5/08

(52) U.S. Cl. CPC B05D 5/08; B05D 2201/02; B05D 2508/00; B05D 2601/22

(57) ABSTRACT

A problem is to provide a layered film that exhibits favorable liquid-repellent properties with respect to both water and oil and is excellent in transparency, and an efficient production method therefor. A solution is a layered film including a coating layer containing a polyester resin A and fine particles C having surfaces subjected to hydrophobization treatment on a resin substrate film, in which the layered film has a haze value of 10% or less and a water sliding angle of 10 degrees or more and less than 70 degrees, and a production method for the layered film, in which a coating layer is layered using a coating liquid containing a specific solvent.

### TECHNICAL FIELD

The present invention relates to a layered film and a production method therefor. More specifically, the present invention relates to a layered film that exhibits water-repellent and oil-repellent properties and is excellent in transparency, and an efficient production method therefor.

### BACKGROUND ART

Materials having a water-repellent and oil-repellent surface are industrially important in fields where antifouling properties are required. In order to achieve antifouling properties, it is necessary to reduce the interaction between contaminants and the material surface, and antifouling properties are generally achieved by imparting water-repellent and oil-repellent properties to the material surface.

Conventionally, a method is known in which a film excellent in water-repellent and oil-repellent properties is fabricated by using silica fine particles having voids and fine particles having voids through formation of aggregates (for example, see Patent Documents 1 and 2). However, generally the coating method for imparting water-repellent and oil-repellent properties to the film surface has a problem in that the adhesive properties to the substrate is low and the coating layer easily falls off, and it has been difficult to achieve both sufficient water-repellent and oil-repellent properties and adhesive properties to the substrate.

In general, conventionally the coating layer is likely to become cloudy and it has been difficult to maintain the transparency of the film itself. As described above, it has been difficult to achieve both realization of sufficient water-repellent and oil-repellent properties and high transparency.

### PRIOR ART DOCUMENT

### Patent Document

Patent Document 1: JP-A-2006-106507
Patent Document 2: JP-A-2004-272198

### SUMMARY OF THE INVENTION

The present invention has been devised in view of the problems of the conventional techniques. In other words, an object of the present invention is to provide a layered film that exhibits favorable liquid-repellent properties with respect to both water and oil and is excellent in transparency, and an efficient production method therefor.

### Means for Solving the Problems

As a result of intensive studies to achieve the object, the present inventors have found out that the above problems can be solved by the following means, and have reached the present invention. In other words, the present invention consists of the following configuration.

1. A layered film comprising a coating layer containing a polyester resin A and fine particles C having surfaces subjected to hydrophobization treatment on a resin substrate film, wherein the layered film has a haze value of 10% or less and a water sliding angle of 10 degrees or more and less than 70 degrees,
provided that at least a portion of a solvent B contained in a coating liquid for formation of the coating layer containing the polyester resin A and the fine particles C having the surfaces subjected to hydrophobization treatment satisfies following requirements:
in a case where a dispersion term, a polarization term, and a hydrogen bond term of the polyester resin A are respectively δd₁, δp₁, and δh₁ and an interaction radius is R₀, a dispersion term, a polarization term, and a hydrogen bond term of an HSP value of the solvent B are respectively δd₂, δp₂, and δh₂, and a dispersion term, a polarization term, and a hydrogen bond term of an HSP value of the fine particles C having the surfaces subjected to hydrophobization treatment are respectively δd₃, δp₃, and δh₃ and an interaction radius is R₁, relation of distances between substances is expressed by following Equations (1) and (2),
relation of distances between HSP values of the polyester resin A and the solvent B

$${( {R}_{A - B} )}^{2} = 4 {( δ {d}_{2} - δ {d}_{1} )}^{2} + {( δ {p}_{2} - δ {p}_{1} )}^{2} + {( δ {h}_{2} - δ {h}_{1} )}^{2} \qquad ( 1 )$$

relation of distances between HSP values of the fine particles C having the surfaces subjected to hydrophobization treatment and the solvent B

$${( {R}_{C - B} )}^{2} = 4 {( δ {d}_{2} - δ {d}_{3} )}^{2} + {( δ {p}_{2} - δ {p}_{3} )}^{2} + {( δ {h}_{2} - δ {h}_{3} )}^{2} \qquad ( 2 )$$

at this time, relative energy differences (RED), which are an index representing affinity of the solvent B for the polyester resin A and the fine particles C having the surfaces subjected to hydrophobization treatment, are expressed by Equations (3) and (4), respectively, for example, when a distance R_{A-B} between HSP values of the polyester resin A and the solvent B is equal to a radius of Hansen dissolution sphere of the polyester resin A, (RED)_{AB}=1,

$$relative energy difference {( RED )}_{AB} = ( {R}_{A - B} ) / {R}_{0} \qquad ( 3 )$$

$$relative energy difference {( RED )}_{CB} = ( {R}_{C - B} ) / {R}_{1} \qquad ( 4 )$$

a solvent B having an HSP value present in a range where Formula (5) is satisfied is used as a solvent for the polyester resin A and the fine particles C having surfaces subjected to hydrophobization treatment, the solvent may be a single solvent or a mixed solvent of a plurality of substances:

$$( {R}_{A - B} ) / {R}_{0} \leq 1.5 and ( {R}_{C - B} ) / {R}_{1} \leq 0.75 . \qquad ( 5 )$$

2. The layered film according to 1 above, wherein a coating layer surface has a decane contact angle of 40 degrees or more.
3. The layered film according to 1 or 2 above, wherein when an atomic composition ratio is determined in a 10 nm deep region from a coating layer surface by measurement using an X-ray photoelectron spectrometer (ESCA), a ratio of fluorine atoms is 20 at % or more.
4. The layered film according to any one of 1 to 3 above, in which the fine particles C having surfaces subjected to hydrophobization treatment have an average primary particle size of 30 nm to 500 nm.
5. The layered film according to any one of 1 to 4 above, wherein the resin substrate film is a polyethylene terephthalate film or a polyethylene naphthalate film.
6. A production method for a layered film including a coating layer containing a polyester resin A and fine particles C having surfaces subjected to hydrophobization treatment on a resin substrate film, wherein the layered film has a haze value of 10% or less and a water sliding angle of 10 degrees or more and less than 70 degrees and a solvent B used during mixing of at least the polyester resin A and the fine particles C having the surfaces subjected to hydrophobization treatment in preparation of a coating liquid for formation of the coating layer satisfies following requirements:
in a case where a dispersion term, a polarization term, and a hydrogen bond term of the polyester resin A are respectively δd₁, δp₁, and δh₁ and an interaction radius is R₀, a dispersion term, a polarization term, and a hydrogen bond term of an HSP value of the solvent B are respectively δd₂, δp₂, and δh₂, and a dispersion term, a polarization term, and a hydrogen bond term of an HSP value of the fine particles C having the surfaces subjected to hydrophobization treatment are respectively δd₃, δp₃, and δh₃ and an interaction radius is R₁, relation of distances between substances is expressed by following Equations (1) and (2),
relation of distances between HSP values of the polyester resin A and the solvent B

$${( {R}_{A - B} )}^{2} = 4 {( δ {d}_{2} - δ {d}_{1} )}^{2} + {( δ {p}_{2} - δ {p}_{1} )}^{2} + {( δ {h}_{2} - δ {h}_{1} )}^{2} \qquad ( 1 )$$

relation of distances between HSP values of the fine particles C having the surfaces subjected to hydrophobization treatment and the solvent B

$${( {R}_{C - B} )}^{2} = 4 {( δ {d}_{2} - δ {d}_{3} )}^{2} + {( δ {p}_{2} - δ {p}_{3} )}^{2} + {( δ {h}_{2} - δ {h}_{3} )}^{2} \qquad ( 2 )$$

at this time, relative energy differences (RED), which are an index representing affinity of the solvent B for the polyester resin A and the fine particles C having the surfaces subjected to hydrophobization treatment, are expressed by Equations (3) and (4), respectively, for example, when a distance R_{A-B} between HSP values of the polyester resin A and the solvent B is equal to a radius of Hansen dissolution sphere of the polyester resin A, (RED)_{AB}=1,

$$relative energy difference {( RED )}_{AB} = ( {R}_{A - B} ) / {R}_{0} \qquad ( 3 )$$

$$relative energy difference {( RED )}_{CB} = ( {R}_{C - B} ) / {R}_{1} \qquad ( 4 )$$

a solvent B having an HSP value present in a range where Formula (5) is satisfied is used as a solvent for the polyester resin A and the fine particles C having surfaces subjected to hydrophobization treatment, the solvent may be a single solvent or a mixed solvent of a plurality of substances:

$$( {R}_{A - B} ) / {R}_{0} \leq 1.5 and ( {R}_{C - B} ) / {R}_{1} \leq 0.75 . \qquad ( 5 )$$

### Effect of the Invention

According to the layered film of the present invention, high droplet removability is exhibited by using a polyester resin as a binder resin to form a coating layer and containing fine particles having surfaces hydrophobized in the coating layer. By using a solvent exhibiting favorable affinity for a polyester resin during mixing of fine particles having surfaces hydrophobized, the transparency of a substrate film is maintained, and this makes it possible to provide a layered film excellent in transparency. According to the present invention, it is possible to provide an efficient production method for the layered film.

### MODE FOR CARRYING OUT THE INVENTION

Hereinafter, the present invention will be described in detail. The present invention provides a layered film that has a coating layer surface exhibiting excellent liquid-repellent properties and is excellent in transparency.

### (Resin Substrate Film)

The layered film in the present invention includes a resin substrate film. The material for this resin substrate film is not particularly limited, but a resin film is preferable from the viewpoint of handling properties such as flexibility. Examples of resins constituting the resin film include polyolefins such as polyethylene, polypropylene, polystyrene, and diene-based polymers; polyesters such as polyethylene terephthalate, polypropylene terephthalate, polybutylene terephthalate, polyethylene naphthalate; polyamides such as nylon 6, nylon 6,6, nylon 6, 10, and nylon 12; polymethyl methacrylate, polymethacrylic acid esters, acrylate-based resins such as polymethyl acrylate and polyacrylic esters; polyacrylic acid-based resins; polymethacrylic acid-based resins; polyurethane-based resins; cellulose-based resins such as cellulose acetate and ethyl cellulose; aromatic hydrocarbon-based polymers such as polyarylate, aramid, polycarbonate, polyphenylene sulfide, polyphenylene oxide, polysulfone, polyethersulfone, polyetheretherketone, polyetherimide, polyimide, polyamideimide, polybenzimidazole, polybenzoxazole, and polybenzothiazole; fluorine-based resins such as polytetrafluoroethylene and polyvinylidene fluoride; epoxy resins; phenol resins; novolac resins; and benzoxazine resins. Among these, from the viewpoint of transparency and dimensional stability, films formed of a polyester resin and an acrylate resin are preferable. Specific examples of the polyester resin include polyethylene terephthalate, polypropylene terephthalate, polybutylene terephthalate, and polyethylene naphthalate. Among these, polyethylene terephthalate and polyethylene naphthalate are preferable from the viewpoint of physical properties, and polyethylene terephthalate is particularly preferable from the viewpoint of a balance between physical properties and cost.

The resin substrate film may be a single layer, or two or more layers layered. In a case where two or more layers are layered, films of the same type or different types can be layered. A resin composition may be layered on the resin substrate film. Various additives can be contained in the resin substrate film if necessary, as long as the effects of the present invention are exerted. Examples of the additives include antioxidants, light stabilizers, anti-gelling agents, organic wetting agents, anti-static agents, ultraviolet absorbers, and surfactants. In a case where the resin substrate film is composed of two or more layers, additives can be contained depending on the function of each layer. In order to improve handling properties such as slipperiness and winding properties of the resin substrate film, inert particles may be contained in the resin substrate film.

In the present invention, the thickness of the resin substrate film is not particularly limited, but is preferably 5 μm or more and 300 μm or less. The thickness is more preferably 10 μm or more and 280 μm or less, still more preferably 12 μm or more and 260 μm or less. It is easy to perform application when a coating layer is layered when the thickness is 5 μm or more, and it is advantageous in terms of cost when the thickness is 300 μm or less.

A resin substrate film having the surface untreated may be used, but it is also possible to use a resin substrate film that is subjected to surface treatment such as plasma treatment, corona treatment, or flame treatment and is coated with a primer layer.

### (Fine Particles C Having Surfaces Subjected to Hydrophobization Treatment)

The layered film in the present invention includes a coating layer on a resin substrate film directly or with another layer interposed therebetween, and the coating layer contains fine particles C having surfaces subjected to hydrophobization treatment. Hereinafter, fine particles having surfaces subjected to hydrophobization treatment is sometimes referred to as surface-modified fine particles, but there is no major difference in meaning between the two terms. The type of fine particles is not particularly limited. For example, at least one of silica (silicon dioxide), alumina, titania, or zirconia can be used. These may be synthesized via arbitrary compounds, or known or commercially available ones may be used. In particular, silica (silicon dioxide) fine particles are preferable since it is easy to perform surface treatments described below on silica.

The fine particles C have surfaces subjected to hydrophobization treatment, but the treatment method is not particularly limited, and for example, hydrophilic oxide fine particles may be subjected to surface modification. In other words, those that are obtained by subjecting hydrophilic oxide fine particles to surface modification using an arbitrary reagent such as a silane coupling agent, and have treated surfaces can be used.

As the hydrophobization treatment method for fine particles typified by silica fine particles, surface treatment using various known reagents such as silicone oil, silane coupling agents, and silazane are suitably used. In particular, from the viewpoint of exhibiting excellent water-repellent and oil-repellent properties, it is more preferable to introduce fluorine-based functional groups such as a 1H,1H,2H,2H-perfluorooctyl group, a 1H,1H,2H,2H-perfluorodecyl group, a 1H,1H,2H,2H-perfluorohexyl group, and a 3,3,3-trifluoropropyl group, alkyl groups typified by a methyl group, an ethyl group, a n-propyl group, an isopropyl group, a n-butyl group, an isobutyl group, a sec-butyl group, a tert-butyl group, and an octyl group, an alkenyl group, an alkynyl group, a vinyl group, a cyclohexyl group, a styryl group, a phenyl group, a trimethylsilyl group and the like into the surface. Among these, from the viewpoint of exhibiting superior water-repellent and oil-repellent properties, oxide fine particles into which a 1H,1H,2H,2H-perfluoroalkyl group is introduced are preferable, and silica fine particles into which a 1H,1H,2H,2H-perfluorooctyl group is introduced are particularly preferable.

In the present invention, when the atomic composition ratio is determined in a 10 nm deep region from the coating layer surface by measurement using an X-ray photoelectron spectrometer (ESCA), the ratio of fluorine atoms is preferably 20 at % or more from the viewpoint of water-repellent and oil-repellent properties. The ratio of fluorine atoms is still more preferably 25 at % or more, particularly preferably 30 at % or more. The ratio of fluorine atoms is preferably high, but may be 50 at % or less.

The primary particle size of the fine particles C in the present invention is preferably 5 nm or more and 2 μm or less, more preferably 20 nm or more and 1.5 μm or less, still more preferably 30 nm or more and 1 μm or less, most preferably 30 nm or more and 500 nm or less. It is preferable that the primary particle size is 5 nm or more since it is easy to form unevenness on the surface layer of the coating layer and the contact angle described below is likely to increase. Meanwhile, it is preferable that the primary particle size is 2 μm or less since fine particles are less likely to fall off from the coating layer and it is easy to maintain the transparency of the resin substrate film. In the present invention, the size of the average primary particle size can be determined as a result of morphological observation using a microscope such as a scanning electron microscope or transmission electron microscope. Specifically, the average diameter of 20 fine particles arbitrarily selected in the microscopic observation is taken as the average primary particle size. The average primary particle size of fine particles having an indefinite shape can be calculated as an equivalent circle diameter. The equivalent circle diameter is a value obtained by dividing the area of the observed fine particles by n, calculating the square root, and doubling the square root.

In the present invention, as a coating layer of the layered film, it is preferable to have a coating layer containing the polyester resin A and the fine particles C having surfaces subjected to hydrophobization treatment. The coating layer may be only a coating layer containing the polyester resin A and the fine particles C having surfaces subjected to hydrophobization treatment, or two or more coating layers including other coating layers may be layered. In a case where two or more coating layers are layered, the coating layer containing the polyester resin A and the fine particles C having surfaces subjected to hydrophobization treatment is preferably the outermost coating layer from the viewpoint of water-repellent and oil-repellent properties and antifouling properties. The composition of a coating layer (sometimes called the first coating layer) located between the resin substrate film and the coating layer containing the polyester resin A and the fine particles C having surfaces subjected to hydrophobization treatment can be selected in consideration of the adhesive properties to the resin substrate film and the coating layer containing the polyester resin A and the fine particles C having surfaces subjected to hydrophobization treatment. The first coating layer is preferably one that does not impair the transparency of the layered film.

### (Binder Resin)

The binder resin used for formation of the coating layer in the present invention is not particularly limited as long as it is a component that can be well bonded to the resin substrate film. For example, it is preferable to use a polyester resin, an acid-modified polyolefin resin, a polyurethane resin, an epoxy resin, or an acrylic resin. It is preferable to use a polyester resin or an acid-modified polyolefin resin in the first coating layer from the viewpoint of adhesive properties to the resin substrate film, and it is preferable to use a polyester resin in the second coating layer from the viewpoint of improving liquid-repellent properties and maintaining film transparency. In the present invention, a polyester resin as described above is referred to as the polyester resin A in some cases.

The polyester resin A that is preferably used as the binder resin in the coating layer is not particularly limited, but polyester resins such as VYLON (registered trademark) series manufactured by TOYOBO CO., LTD. are suitably used.

The binder resin may be mixed with a curing agent and crosslinked before use, and the curing agent used is preferably an isocyanate, epoxy, melamine, or a carboxylic acid, and more preferably epoxy or melamine. These makes it possible to form a coating layer containing the fine particles C having surfaces subjected to hydrophobization treatment while maintaining the transparency of the resin base film.

### (Other Components in Coating Layer)

The coating layer in the present invention may contain components other than the fine particles C having surfaces subjected to hydrophobization treatment. Specific examples thereof include binder components, antioxidants, curing agents, light stabilizers, anti-gelling agents, organic wetting agents, antistatic agents, ultraviolet absorbers, and surfactants, and these components can be appropriately contained if necessary.

### (Structure of Coating Layer)

The total thickness of coating layers is preferably 5 nm or more, more preferably 10 nm or more, still more preferably 30 nm or more, particularly preferably 50 nm or more from the viewpoint of satisfying the adhesive properties between the coating layer and the resin substrate film. The total thickness of coating layers is preferably 3 μm or less, more preferably 2 μm or less, still more preferably 1.5 μm or less, particularly preferably 1.2 μm or less in consideration of the transparency of coating layers and economic efficiency.

The solid content in the coating liquid is preferably 0.5% by mass or more and 20% by mass or less, more preferably 1% by mass or more and 15% by mass or less, still more preferably 1.5% by mass or more and 10% by mass or less. It is preferable that the solid content in the coating liquid is in the above range since the unevenness of the fine particles are likely to be exposed onto the coating surface layer and the coating properties are also favorable.

The range of the mixing ratio (binder resin:fine particles) of the fine particles to the binder resin is preferably 90:10 to 5:95, more preferably 70:30 to 5:95, still more preferably 50:50 to 5:95. It is preferable that the mixing ratio is in the above range since it is possible to form a state in which unevenness of the fine particles are realized on the surface but the fine particles are less likely to fall off from the binder.

### (Hansen Solubility Parameter: HSP)

The Hansen solubility parameters (HSP) refer to vector quantity parameters obtained by dividing the Hildebrand solubility parameter into three cohesive energy components of London dispersion forces, dipole-dipole forces, and hydrogen bond forces. In the present invention, the component corresponding to the London dispersion forces of HSP is referred to as a dispersion term (hereinafter also referred to as “δd”), the component corresponding to the dipole-dipole forces is referred to as a polar term (hereinafter also referred to as “δp”), and the component corresponding to the hydrogen bond forces is referred to as a hydrogen bond term (hereinafter also referred to as “δh”). Since HSP is a vector quantity, it is known that there are almost no pure substances that have exactly the same value. A database has been constructed regarding HSP of generally used substances. Therefore, those skilled in the art can obtain the HSP value of a desired substance by referring to the database. Those skilled in the art can calculate the HSP values of substances of which the HSP values are not registered in the database from their chemical structures by using computer software such as Hansen Solubility Parameters in Practice (HSPiP). Alternatively, the HSP values can be determined by conducting a dissolution test for substances of which the HSP values are not registered using a plurality of solvents of which the HSP values are known and inputting the obtained solubility into HSPiP. In the case of a mixture of a plurality of substances, the HSP value of the mixture is calculated as the sum of the values obtained by multiplying the HSP value of each substance as a contained component by the volume ratio of the substance to the entire mixture. Regarding HSP values, reference can be made to, for example, Hiroshi Yamamoto, S. Abbott, C. M. Hansen, Kagaku Kogyo, March 2010 issue. Regarding HSP, reference can be made to, for example, Hiroshi Yamamoto, S. Abbott, C. M. Hansen, Kagaku Kogyo, April 2010 issue. The HSP value of the polyester resin A, which is a binder resin in this specification, and the interaction radius R₀ with the solvent B were determined using the dissolution test method described in S. Abbott, C. M. Hansen, Kagaku Kogyo, March 2010 issue and Hiroshi Yamamoto, S. Abbott, C. M. Hansen, Kagaku Kogyo, April 2010 issue. Since the dissolution test method cannot be applied to the fine particles C having surfaces subjected to hydrophobization treatment, the HSP value of the fine particles C having surfaces subjected to hydrophobization treatment and the interaction radius R₁ with the solvent B were determined using the sedimentation test method described below.

The Hansen solubility parameters of various resins and fine particles are values that change depending on the monomer structure, molecular weight, molecular weight distribution, crystallinity, surface modification rate, and the like.

The interaction radius R₀ indicates the distance from the center coordinates where the target substance exhibits solubility when the coordinates of the solubility parameters (HSP) of the target substance in the Hansen space are set as the center coordinates. The interaction radius R₀ is usually determined by conducting a solubility test in which the target substance is dissolved in various solvents of which the HSPs have been determined. Specifically, when the coordinates of the Hansen solubility parameters of all solvents used in the solubility test are plotted in the Hansen space, a sphere (dissolution sphere) is found in which the coordinates of the solvent that dissolves the target substance are inside the sphere and the coordinates of the solvent that does not dissolve the target substance are outside the sphere, and the radius of the dissolution sphere is taken as the interaction radius R₀ of the target substance.

Generally, the distance R_{X-Y} between the Hansen solubility parameters of a substance X and the Hansen solubility parameters of a substance Y satisfies the following Relational Expression (6). Provided that δd_{X}, δp_{X}, and δh_{X} represent the dispersion term, polarization term, and hydrogen bond term of the Hansen solubility parameters of the substance X, respectively. In addition, δd_{Y}, δp_{Y}, and δh_{Y} represent the dispersion term, polarization term, and hydrogen bond term of the Hansen solubility parameters of the substance Y, respectively.

$${( {R}_{X - Y} )}^{2} = 4 {( δ {d}_{Y} - δ {d}_{X} )}^{2} + {( δ {p}_{Y} - δ {p}_{X} )}^{2} + {( δ {h}_{Y} - δ {h}_{x} )}^{2} \qquad ( 6 )$$

Generally, the relative energy difference (RED), which is an index representing the affinity of the substances X and Y for each other, is expressed by the following General Formula (7) in a case where the substances are both dissolved in a solvent.

Relative energy difference (RED)_{XY}=(R_{X-Y})/R₀ (7)

In the present invention, the distance Ra-b between the Hansen solubility parameters of the polyester resin A and the Hansen solubility parameters of the solvent B has the relation expressed by the following Equation (1). Provided that δd₁, δp₁, and δh₁ represent the dispersion term, polarization term, and hydrogen bond term of the Hansen solubility parameters of the polyester resin A, respectively. In addition, δd₂, δp₂, and δh₂ represent the dispersion term, polarization term, and hydrogen bond term of the Hansen solubility parameters of the solvent B, respectively.

$${( {R}_{A - B} )}^{2} = 4 {( δ {d}_{2} - δ {d}_{1} )}^{2} + {( δ {p}_{2} - δ {p}_{1} )}^{2} + {( δ {h}_{2} - δ {h}_{1} )}^{2} \qquad ( 1 )$$

In the present invention, the relative energy difference (RED)_{AB}, which is an index representing the affinity of the polyester resin A and the solvent B for each other, is expressed by the following General Formula (3). At this time, for example, when the distance R_{A-B} between the HSP values of the polyester resin A and the solvent B is equal to the radius of the Hansen dissolution sphere of the polyester resin A, (RED)_{AB}=1.

$$Relative energy difference {( RED )}_{AB} = ( {R}_{A - B} ) / {R}_{0} \qquad ( 3 )$$

### (Sedimentation Test Method)

The dissolution test method is suitably used as a method to determine the HSP values of resins and solvents, but fine particles do not dissolve in solvents and it is necessary to determine the HSP values thereof by other methods. In the present invention, a sedimentation test method was used to determine the HSP value of the fine particles C having surfaces subjected to hydrophobization treatment. The specific examination procedure is as follows.

First, the HSP value of the compound used to modify the fine particles C having surfaces subjected to hydrophobization treatment is found using the computer software HSPiP. At this time, in a case where the site that binds to the silica particles is a polar functional group, by finding the HSP value with the structure converted to a nonpolar functional group, selection of the subsequent test solvent is likely to be appropriately performed.

Next, referring to the found HSP values of the modification compounds, 10 or more solvents to be used in the sedimentation test method are selected. At this time, HSP values can be estimated more accurately by selecting solvents with different HSP values so as to minimize bias in the Hansen space. By determining a somewhat appropriate estimate of the HSP value in the previous step, it becomes possible to select a test solvent based on the estimated HSP value.

Into a sample bottle, 0.1 g of the weighed fine particles C having surfaces subjected to hydrophobization treatment is placed, and 10 ml of the test solvent selected by the above-mentioned method is added. After that, the sample bottle is irradiated with ultrasonic waves for 5 minutes using an ultrasonic cleaning machine, and the same treatment is performed on the sample bottles using all the dispersion solvents. After irradiation with ultrasonic waves, the sample bottles were left to still stand at room temperature for 1 hour, and then the dispersion state was visually judged and scored.

The criteria for scoring are as follows.
1 Particles are uniformly dispersed
2 Particles are almost uniformly dispersed, but slightly sedimented
3 Most of particles are uniformly dispersed, but 20% to 50% of particles are sedimented
4 Some of particles are dispersed, but 50% to 80% of particles are sedimented
5 Some of particles are dispersed, but 80% or more of particles are sedimented
6 Particles are completely sedimented

By inputting this result into the computer software HSPiP and defining only score 1 as the inside of the Hansen dissolution sphere, the HSP value of the fine particles and the Hansen dissolution sphere can be determined.

### (Solvent B)

The solvent used during mixing of the polyester resin A and the fine particles C having surfaces subjected to hydrophobization treatment may be a single solvent or a mixture of a plurality of solvents, and by using a solvent that exhibits high affinity for the polyester resin A and the fine particles C having surfaces subjected to hydrophobization treatment, a film exhibiting higher transparency can be fabricated. Regarding the affinity of the solvent B for the polyester resin A and the fine particles C having surfaces subjected to hydrophobization treatment, the HSP values can be referred to. In a case where the dispersion term, polarization term, and hydrogen bond term of the Hansen solubility parameters of the HSP value of the fine particles C having surfaces subjected to hydrophobization treatment are respectively δd₃, δp₃, and δh₃ and the interaction radius is R₁, the distance between the HSP values of the fine particles C having surfaces subjected to hydrophobization treatment and the solvent B is expressed by the following Relational Expression (2). The interaction radius R₁ of the fine particles having surfaces subjected to hydrophobization treatment is calculated by inputting the results of a sedimentation test into HSPiP.

$${( {R}_{C - B} )}^{2} = 4 {( δ {d}_{2} - δ {d}_{3} )}^{2} + {( δ {p}_{2} - δ {p}_{3} )}^{2} + {( δ {h}_{2} - δ {h}_{3} )}^{2} \qquad ( 2 )$$

At this time, the relative energy difference (RED)_{CB}, which is an index representing the affinity of the solvent B for the fine particles C having surfaces subjected to hydrophobization treatment, is expressed by Equation (4).

Relative energy difference (RED)_{CB}=(R_{C-B})/R₁ (4)

In the present invention, a solvent B having an HSP value present in a range where Relational Expression (5) is satisfied is used as the solvent for the polyester resin A and the fine particles C having surfaces subjected to hydrophobization treatment. The solvent B may be a single solvent or a mixed solvent of a plurality of substances.

$$( {R}_{A - B} ) / {R}_{0} \leq 1.5 and ( {R}_{C - B} ) / {R}_{1} \leq 0.75 \qquad ( 5 )$$

Examples of solvents that satisfy (R_{A-B})/R₀≤1.5 include 2-cyclopentyl alcohol, ethylene dibromide, 1,4-dioxane, 1,2-ethanedithiol, and 2-methyl-1-butanol. Examples of solvents that satisfy (R_{C-B})/R₁≤0.75 include 1-chloro-2-butene, ethyl bromide, 1-chlorohexane, methyl ethyl ketone, and methyl isobutyl ketone. A mixed solvent may be used as the solvent, and when a mixed solvent that satisfies (R_{A-B})/R₀≤1.5 is expressed in terms of mixing ratio by mass, examples include methyl ethyl ketone:1,4-dioxane=1:9 to 9:1, 1,4-dioxane:acetone=1:9 to 9:1, toluene:methyl ethyl ketone=0:10 to 9:1, dimethyl cellosolve:n-butyl acetate=1:9 to 9:1, and acetone:methyl isobutyl ketone=1:9 to 9:1, and when a mixed solvent that satisfies (R_{C-B})/R₁≤0.75 is expressed in terms of mixing ratio by mass, examples include 1-chloro-2-butene:bromotrichloromethane=5:5 to 10:0, 2-chlorobutane:o-difluorobenzene=1:9 to 9:1, 1-chlorohexane:3-ethoxypropionaldehyde=3:7 to 10:0, toluene:methyl ethyl ketone=0:10 to 5:5, and methyl ethyl ketone:cyclohexane=4:6 to 10:0.

When a solvent that satisfies (R_{A-B})/R₀≤1.5 and (R_{C-B})/R₁≤0.75 is expressed in terms of mixing ratio by mass, examples include xylene:methyl ethyl ketone=1:9 to 5:5, toluene:methyl ethyl ketone=0:10 to 5:5, acetonitrile:cyclohexane=2:8 to 6:4, and methyl ethyl ketone:cyclohexane=4:6 to 10:0. The value of relative energy difference (RED)_{AB} is preferably 1.5 or less, more preferably 1.0 or less, most preferably 0.5 or less. The value of (RED)_{AB} is preferably small, but may be 0.1 or more. The value of (RED)_{CB} is preferably 0.75 or less, more preferably 0.5 or less, most preferably 0.4 or less. The value of (RED)_{CB} is preferably small, but may be 0.1 or more.

In the present invention, in the preparation of a coating liquid for formation of the coating layer containing the polyester resin A and the fine particles C having surfaces subjected to hydrophobization treatment, it is preferable that the solvent B used during mixing of at least the polyester resin A and the fine particles C having surfaces subjected to hydrophobization treatment satisfies the above-mentioned requirements from the viewpoint of transparency of the layered film. Hence, it is not necessary that all the solvents contained in the intermediate solution and suspension prepared in the process up to the preparation of the coating liquid for the coating layer of the layered film satisfy the above-mentioned requirements, but it is still more preferable that all the solvents contained in the intermediate solution and suspension prepared in the process up to the preparation of the coating liquid for the coating layer of the layered film satisfy the above-mentioned requirements from the viewpoint of transparency of the layered film. It is particularly preferable that all the solvents contained in the intermediate solution and suspension prepared in the process up to the preparation of the coating liquid for the coating layer of the layered film satisfy the above-mentioned requirements and are solvents having the same composition from the viewpoint of transparency of the layered film.

In the drying process after coating, it is preferable to completely remove the solvent, and it is preferable to use a solvent having a boiling point of 150 degrees or less in view of the heat resistance of the substrate film.

### (Primary Particle Size of Fine Particles C Having Surfaces Subjected to Hydrophobization Treatment)

The primary particle size can be determined as a result of morphological observation using a microscope such as a scanning electron microscope or transmission electron microscope. Specifically, the average diameter of 20 particles arbitrarily selected in the microscopic observation is taken as the average primary particle size.

### (Transparency)

In the present invention, regarding the transparency of the resin substrate film, the transparency is preferably maintained after the coating layer is provided on the resin substrate film to form a layered film, and the haze value is preferably 10% or less. The haze value is still more preferably 9% or less. The haze value is preferably small, but the haze value is usually 0.1% or more.

### (Liquid-Repellent Properties)

The water-repellent and oil-repellent properties and liquid-repellent properties of the layered film according to the present invention can be evaluated by known methods. Specifically, oil-repellent properties can be mainly evaluated by contact angle measurement using decane, specifically n-decane. The contact angle range of decane in the present invention is preferably 40 degrees or more, more preferably 50 degrees or more. It is more preferable as the contact angle of decane is larger, and the upper limit is not particularly limited, but realistically the upper limit is about 150 degrees. It is preferable that the contact angle of decane is 40 degrees or more from the viewpoint of imparting oil-repellent properties that can suppress oil stains and the like, and it is more preferable that the contact angle of decane is 50 degrees or more since oil-repellent properties equal to or higher than that of conventional fluorine-based resin sheets are exhibited.

### (Dynamic Liquid-Repellent Properties)

The dynamic liquid-repellent properties of the layered film according to the present invention can be evaluated by the following two methods. In other words, the two methods are measurement of the sliding angle of the layered film and evaluation of the mass change rate after immersion in oil. In the present invention, measurement of the sliding angle is mainly used.

### (Measurement of Sliding Angle)

The sliding angle can be measured by a known method. In the present invention, the preferred range of the sliding angle of water is preferably 10 degrees or more and less than 70 degrees. It is preferable that the sliding angle is 10 degrees or more and less than 70 degrees since the droplets slide down without being pinned on the substrate. A state where a sliding trace of the droplet does not remain after sliding down is preferable since it can be said that the droplet has been completely removed. The sliding angle is more preferably 10 degrees or more and 50 degrees or less.

### (1) Hansen Solubility Parameter (HSP) Value and Interaction Radius

The dispersion term (δd₂), polarization term (δp₂), and hydrogen bond term (δh₂) of the HSP values of the solvents B used in Examples and Comparative Examples described below were each referred to constants registered in a known database.

Regarding the dispersion term (δd₁), polarization term (δp₁) and hydrogen bond term (δh₁) of the HSP value of the polyester resin A used as a binder, the HSP value was calculated by performing a dissolution test using a solvent with known HSP.

Regarding the dispersion term (δd₃), polarization term (δp₃), and hydrogen bond term (δh₃) of the HSP value of fluorine-modified silica particles, which were the fine particles C having surfaces hydrophobized, the HSP value was calculated by performing a sedimentation test using a solvent with known HSP.

### (Production Process of Layered Film)

In production of the layered film of the present invention, the coating method is not particularly limited. For example, the layered film can be fabricated according to known methods such as roll coating, gravure coating, bar coating, doctor blade coating, spin coating, spray coating, and brush coating. The solvent used when coating is performed by these methods is not particularly limited, but it is necessary to appropriately select and use an organic solvent that exhibits favorable affinity for the binder resin. These solvents may be used singly or in mixture of the plurality of solvents. The content of the fine particles having surfaces hydrophobized to the solvent can be selected at an arbitrary proportion so that a uniform dispersion is obtained. The drying method after coating may be either natural drying or heat drying, but heat drying is more preferable from the viewpoint of industrial production. The drying temperature is not particularly limited as long as it does not affect the components contained in the resin substrate film and coating layer, but usually is preferably 150° C. or less, more preferably 50° C. or more and 140° C. or less. The drying method is not particularly limited, and a known method for drying a film, such as a hot plate or hot air oven, can be used. The drying time is appropriately selected depending on other conditions such as drying temperature, but may be in a range where the components contained in the resin substrate film and coating layer are not affected. The coating process may be a so-called offline coating method performed in a separate process after formation of the resin substrate film, or a so-called in-line coating method in which a coating liquid is applied to an un-stretched sheet or a uniaxially stretched film and stretched in at least one direction in the production process of the resin substrate film.

### EXAMPLES

Hereinafter, the present invention will be further explained with reference to specific Examples, but the present invention is not limited to the aspects of these Examples. First, the evaluation methods adopted in the present invention will be explained.

### <Evaluation Methods>

Evaluation in Examples and Comparative Examples was performed by the following measurement methods.

### (Hansen Solubility Parameter (HSP) Value and Interaction Radius)

The dispersion term (δd₂), polarization term (δp₂), and hydrogen bond term (δh₂) of the HSP values of the solvents used in Examples and Comparative Examples were each referred to constants registered in a known database.

Regarding the dispersion term (δd₁), polarization term (δp₁) and hydrogen bond term (δh₁) of the HSP value of RV280 as a binder resin corresponding to the polyester resin A in the present invention, the HSP value was calculated by performing a dissolution test using a solvent with known HSP.

Regarding the dispersion term (δd₃), polarization term (δp₃), and hydrogen bond term (δh₃) of the HSP value of silica fine particles corresponding to the fine particles C having surfaces subjected to hydrophobization treatment in the present invention, the HSP value was calculated by performing a sedimentation test using a solvent with known HSP.

Next, the following equations:

$${( Ra - b )}^{2} = 4 {( δ {d}_{2} - δ {d}_{1} )}^{2} + {( δ {p}_{2} - δ {p}_{1} )}^{2} + {( δ {h}_{2} - δ {h}_{1} )}^{2}$$

$${( Rc - b )}^{2} = 4 {( δ {d}_{3} - δ {d}_{1} )}^{2} + {( δ {p}_{3} - δ {p}_{1} )}^{2} + {( δ {h}_{3} - δ {h}_{1} )}^{2}$$

[in the equations,
δd₁ is the dispersion term of HSP of the binder resin,
δp₁ is the polarization term of HSP of the binder resin,
δh₁ is the hydrogen bond term of HSP of the binder resin,
δd₂ is the dispersion term of HSP of the solvent,
δp₂ is the polarization term of HSP of the solvent,
δh₂ is the hydrogen bond term of HSP of the solvent,
δd₃ is the dispersion term of HSP of the silica fine particles,
δp₃ is the polarization term of HSP of the silica fine particles,
δh₃ is the hydrogen bond term of HSP of the silica fine particles,
Ra-b is the distance between the HSP values of the binder resin and the solvent in the HSP space, and Rc−b is the distance between the HSP values of the silica fine particles and the solvent in the HSP space.]

The distance “Ra-b” between the HSP values of the binder resin and the solvent and the distance “Rc−b” between the HSP values of the silica fine particles and the solvent were calculated.

The interaction radius (R₀) of the binder resin was calculated by inputting the results of a dissolution test into HSPiP. The interaction radius (R₁) of the silica fine particles was calculated by inputting the results of a sedimentation test into HSPiP.

### (Measurement of Contact Angle)

The contact angle of the solvent on the coating layer surface of the fabricated layered film was measured. A contact angle meter DM-501 manufactured by Kyowa Interface Science Co., Ltd. was used for contact angle measurement. n-Decane was used as the measurement solvent. The contact angle of n-decane (hereinafter sometimes abbreviated as DCA) was measured 10 seconds after dropping of 1.8 μL of n-decane droplet.

### (Measurement of Sliding Angle)

A layered film cut into a strip of approximately 2 cm×5 cm was used to measure the sliding angle. The measurement was performed using a fully automatic contact angle meter DMo-701 manufactured by Kyowa Interface Science Co., Ltd., water was used in a volume of 30 μL for the measurement, and the angle of stage inclination at the point where the droplet moved by 30 dots was taken as the sliding angle.

### (Measurement of Average Primary Particle Size)

The average primary particle size of the fine particles having surfaces hydrophobized was determined by the results of observation using a scanning electron microscope or a transmission electron microscope. Specifically, the average diameter of 20 fine particles arbitrarily selected in the microscopic observation was taken as the average primary particle size. The average primary particle size of fine particles having an indefinite shape can be calculated as an equivalent circle diameter. The equivalent circle diameter is a value obtained by dividing the area of the observed fine particles by n, calculating the square root, and doubling the square root.

(Ratio of Fluorine Atom at Depth of 10 nm from Coating Layer Surface)

The ratio of fluorine atoms on the coating layer surface can be calculated from the measurement results using an X-ray photoelectron spectrometer (ESCA). The composition was analyzed in a 10 nm deep region from the surface of the coating layer of the layered film.
K-Alpha⁺ (manufactured by Thermo Fisher Scientific Inc.) was used as the instrument.

Details of the measurement conditions are presented below. At the time of analysis, the background was removed by the shirley method.

The surface composition ratio was the average value of the measurement results at three or more places.
Measurement conditions
Excited X-rays: Monochromatic Al Kα rays
X-ray output: 12 kV, 6 mA
Photoelectron escape angle: 90 degrees
Spot size: 400 μmΦ
Pass energy: 50 eV
Step: 0.1 eV

### (Haze Value)

The haze value was measured using HAZE METER NDH 5000 manufactured by NIPPON DENSHOKU INDUSTRIES CO., LTD. The haze value was measured at three points in a 50 mm×80 mm coating film, and the average value thereof was determined.

Reagents used in Examples and Comparative Examples are listed below.
VYLON (registered trademark) RV280 (Polyester resin manufactured by TOYOBO CO., LTD.)
MS-001 (Methylated melamine resin manufactured by SANWA CHEMICAL CO., LTD.)
p-Toluenesulfonic acid monohydrate (Crosslinking catalyst manufactured by NACALAI TESQUE, INC.)

### Preparation Example of Polyester Resin Solution A-1

A polyester resin solution A-1 (solid concentration 5% by mass) was prepared by placing 10 parts by mass of VYLON (registered trademark) RV280 (polyester resin manufactured by TOYOBO CO., LTD.), 57 parts by mass of toluene, and 133 parts by mass of methyl ethyl ketone in a sample bottle and performing stirring at room temperature for 1 hour.

Hereinafter, polyester solutions A-2 to A-6 were prepared in the same manner as the polyester resin solution A-1 except that the solvent was changed as presented in Table 1.

TABLE 1
Polyester resin solution

| | Solvent | |
|---|---|---|
| A-1 | Toluene:methyl ethyl ketone = | 3:7 |
| A-2 | Toluene:methyl isobutyl ketone = | 3:7 |
| A-3 | Xylene:methyl ethyl ketone = | 3:7 |
| A-4 | Acetonitrile:cyclohexane = | 5:5 |

| | |
|---|---|
| A-5 | Toluene |
| A-6 | Ethanol |

### Preparation Example of Polyester Resin Solution B-1

A polyester resin solution B-1 (solid concentration 5% by mass) was prepared by placing 100 parts by mass of polyester solution A-1, 1.5 parts by mass of toluene, 3.5 parts by mass of methyl ethyl ketone, 0.5 parts by mass of melamine resin MS-001 as a crosslinking agent, and 0.01 parts by mass of p-toluenesulfonic acid (PTS) as a crosslinking catalyst in a sample bottle and performing stirring at room temperature for 5 minutes.

Hereinafter, polyester resin solutions B-2 to B-6 were prepared in the same manner as the polyester resin solution B-1 except that the solvent was changed as presented in Table 1.

TABLE 2
Polyester resin solution

| | Solvent | |
|---|---|---|
| B-1 | Toluene:methyl ethyl ketone = | 3:7 |
| B-2 | Toluene:methyl isobutyl ketone = | 3:7 |
| B-3 | Xylene:methyl ethyl ketone = | 3:7 |
| B-4 | Acetonitrile:cyclohexane = | 5:5 |

| | |
|---|---|
| B-5 | Toluene |
| B-6 | Ethanol |

### <Synthesis Method of Silica Fine Particle Dispersion C-1>

In a reaction vessel 1, 100 parts by mass of tetraethoxysilane and 429 parts by mass of ethanol were mixed. In a reaction vessel 2, 179 parts by mass of ethanol, 13 parts by mass of ammonia water (25%), and 37 parts by mass of deionized water were mixed, and then the content s of the reaction vessel 2 were transferred dropwise to the reaction vessel 1. At this time, the solution was added dropwise over 10 minutes to prevent a rapid reaction. After the dropwise addition was completed, the reaction solution was left at 20° C. for 48 hours. Thereafter, ammonia and water were distilled off to prepare a silica fine particle dispersion (average primary particle size 70 nm). Thereafter, 1136 parts by mass of ethanol, 11.4 parts by mass of 1H,1H,2H,2H-perfluorooctyltrichlorosilane, and 3.8 parts by mass of ammonia water (25%) were added to the silica fine particle dispersion, and heating was performed at 65° C. for 2 days to prepare a silica fine particle dispersion D-1 modified with a 1H,1H,2H,2H-perfluorooctyl group. In order to examine the solid concentration in the silica fine particle dispersion, 5 grams of the silica fine particle dispersion was weighed and placed in an aluminum cup (1.3 grams) and heated in an oven at 150° C. for 24 hours or more to remove ethanol and water, residual solvents. When the aluminum cup after the removal was weighed, the weight was 1.4 grams, so the solid content in 5 grams of silica fine particle dispersion was calculated to be 0.1 grams, and the solid concentration in the silica fine particle dispersion was found to be 2% by mass. Thereafter, when a coating liquid was prepared, ethanol in the silica fine particle dispersion was removed, and a mixed solvent of toluene:methyl ethyl ketone=3:7 (mass ratio) was added in the same amount as that of the removed ethanol to prepare a toluene/methyl ethyl ketone dispersion.

Hereinafter, silica fine particle dispersions C-2 to C-6 were prepared in the same manner as the silica fine particle dispersion C-1 except that the solvent was changed as presented in Table 3.

TABLE 3
Silica fine particle dispersion

| | Average | | |
|---|---|---|---|
| | primary | | |
| | particle | | |
| | size (nm) | Solvent | |
| C-1 | 70 | Toluene:methyl ethyl ketone = | 3:7 |
| C-2 | 70 | Toluene:methyl isobutyl ketone = | 3:7 |
| C-3 | 70 | Xylene:methyl ethyl ketone = | 3:7 |
| C-4 | 70 | Acetonitrile:cyclohexane = | 5:5 |

| | | |
|---|---|---|
| C-5 | 70 | Toluene |
| C-6 | 70 | Ethanol |

### Preparation Example of Coating Liquid D-1

In a sample bottle, 40 parts by mass of polyester resin solution A-1 (solid concentration 5% by mass), 100 parts by mass of silica fine particle dispersion C-1 (solid concentration 2% by mass), 74 parts by mass of a mixed solvent of toluene:methyl ethyl ketone=3:7 (mass ratio), 0.2 parts by mass of a crosslinking agent MS-001 (solid concentration 10% by mass), and 0.004 parts by mass of p-toluenesulfonic acid (solid concentration 100% by mass), a catalyst were placed and mixed together to prepare a coating liquid D-1 (solid concentration 2% by mass).

Hereinafter, coating liquids D-2 to D-6 mainly for the second coating layer were prepared in the same manner as the coating liquid D-1 except that the respective substances were mixed as presented in Table 4.

TABLE 4

| Obtained | | | | | | | | | | |
|---|---|---|---|---|---|---|---|---|---|---|
| coating | | Silica | | | | Mixed amount (parts by mass) | | | | |
| liquid for | | fine | | | | | Fine | | | |
| second | Resin | particle | | Curing | | Resin | particle | | Curing | |
| coating | solution | dispersion | | agent | Catalyst | solution | dispersion | | agent | Catalyst |
| layer | used | used | Solvent | used | used | on left | on left | Solvent | on left | on left |
| D-1 | A-1 | C-1 | Toluene:methyl | MS-001 | PTS | 40 | 100 | 74 | 0.2 | 0.004 |
| | | | ethyl ketone = 3:7 | | | | | | | |
| D-2 | A-2 | C-2 | Toluene:methyl | MS-001 | PTS | 40 | 100 | 74 | 0.2 | 0.004 |
| | | | isobutyl ketone = 3:7 | | | | | | | |
| D-3 | A-3 | C-3 | Xylene:methyl | MS-001 | PTS | 40 | 100 | 74 | 0.2 | 0.004 |
| | | | ethyl ketone = 3:7 | | | | | | | |
| D-4 | A-4 | C-4 | Acetonitrile:cyclo- | MS-001 | PTS | 40 | 100 | 74 | 0.2 | 0.004 |
| | | | hexane = 5:5 | | | | | | | |
| D-5 | A-5 | C-5 | Toluene | MS-001 | PTS | 40 | 100 | 74 | 0.2 | 0.004 |
| D-6 | A-6 | C-6 | Ethanol | MS-001 | PTS | 40 | 100 | 74 | 0.2 | 0.004 |

PTS: p-toluenesulfonic acid monohydrate

### <Fabrication of Layered Film>

### Example 1

The polyester resin solution B-2 was applied to the corona-treated surface of Toyobo Ester (registered trademark) film (product number: E5100, thickness: 75 μm), which was a polyethylene terephthalate film (hereinafter sometimes referred to as PET film), using bar coater #5, and then dried at 110° C. for 1 minute to fabricate the first coating layer (the thickness of the first coating layer after drying was 0.6 μm. Thereafter, the coating liquid D-1 prepared by the method described in the Preparation Example of coating liquid was applied using bar coater #3, and then dried at 130° C. for 1 minute to fabricate the second coating layer (the thickness of the second coating layer after drying was 0.14 μm), whereby a layered film was obtained.

Hereinafter, layered films of Examples 2 to 5 were obtained in the same manner as in Example 1 except that the coating liquid applied was changed as presented in Table 5.

### Comparative Example 1

The polyester solution B-1 (solid content 5% by mass) was applied to the corona-treated surface of PET film E5100 using bar coater #5, and then dried at 110° C. for 1 minute to obtain a layered film.

### Comparative Example 2

A layered film of Comparative Example 2 was obtained in the same manner as in Example 1 except that the coating liquid for the first coating layer was changed to B-5 and the coating liquid for the second coating layer was changed to D-5.

### Comparative Example 3

A layered film of Comparative Example 3 was obtained in the same manner as in Example 1 except that the coating liquid for the first coating layer was changed to B-6 and the coating liquid for the second coating layer was changed to D-6.

TABLE 5

| | | First | | Second coating layer | | | | | | | | | Ratio |
|---|---|---|---|---|---|---|---|---|---|---|---|---|---|
| | | coating layer | | | Film | Average | | | | | | | of F |
| | | | Film | | thick- | primary | | | | | | | element |
| | Resin | | thickness | | ness | particle | | | | | Contact | Sliding | in |
| | sub- | Coat- | after | Coat- | after | size of fine | | | | | angle | angle | coating |
| | strate film | ing liquid | drying (μm) | ing liquid | drying (μm) | particles (nm) | Solvent for second coating layer | $\frac{{R}_{C - B}}{{R}_{1}}$ | $\frac{{R}_{A - B}}{{R}_{0}}$ | Haze (%) | (degrees) Decane | (degrees) Water | layer (at %) |
| Example 1 | PET | B-1 | 0.6 | D-1 | 0.6 | 70 | Toluene/methyl | 0.99 | 0.46 | 9 | 52 | 37 | 27.3 |
| | E5100 | | | | | | ethyl ketone = 3/7 | | | | | | |
| Example 2 | PET | B-2 | 0.6 | D-2 | 0.6 | 70 | Toluene/methyl | 1.20 | 0.61 | 9 | 48 | 43 | 30.3 |
| | E5100 | | | | | | isobutyl | | | | | | |
| | | | | | | | ketone = 3/7 | | | | | | |
| Example 3 | PET | B-3 | 0.6 | D-3 | 0.6 | 70 | Xylene/methyl | 0.99 | 0.53 | 9 | 53 | 41 | 25.9 |
| | E5100 | | | | | | ethyl ketone = 3/7 | | | | | | |
| Example 4 | PET | B-4 | 0.6 | D-4 | 0.6 | 70 | Acetonitrile/ | 1.13 | 0.36 | 9 | 53 | 40 | 31 |
| | E5100 | | | | | | cyclohexane = 5/5 | | | | | | |
| Example 5 | PET | None | — | D-1 | 0.6 | 70 | Toluene/methyl | 0.99 | 0.46 | 9 | 49 | 41 | 27.3 |
| | E5100 | | | | | | ethyl ketone = 3/7 | | | | | | |
| Comparative | PET | B-1 | 0.6 | — | — | — | — | — | — | 8 | Less | 52 | Less than |
| Example 1 | E5100 | | | | | | | | | | than 5 | | 0.1 |
| Comparative | PET | B-5 | 0.6 | D-5 | 0.6 | 70 | Toluene | 1.21 | 1.53 | 85 | 50 | More | 25.9 |
| Example 2 | E5100 | | | | | | | | | | | than 70 | |
| Comparative | PET | B-6 | 0.6 | D-6 | 0.6 | 70 | Ethanol | 1.80 | 3.02 | 92 | 48 | More | 29.7 |
| Example 3 | E5100 | | | | | | | | | | | than 70 | |

### Industrial Applicability

According to the present invention, it is possible to provide a layered film that exhibits excellent water-repellent and oil-repellent properties and antifouling properties. The layered film according to the present invention is useful since the layered film is excellent in transparency and can be applied to packaging, coating, industrial use, mold release materials, and other uses.

1. A layered film comprising a coating layer containing a polyester resin A and fine particles C having surfaces subjected to hydrophobization treatment on a resin substrate film, wherein the layered film has a haze value of 10% or less and a water sliding angle of 10 degrees or more and less than 70 degrees,
provided that at least a portion of a solvent B contained in a coating liquid for formation of the coating layer containing the polyester resin A and the fine particles C having the surfaces subjected to hydrophobization treatment satisfies following requirements:
in a case where a dispersion term, a polarization term, and a hydrogen bond term of the polyester resin A are respectively δd₁, δp₁, and δh₁ and an interaction radius is R₀, a dispersion term, a polarization term, and a hydrogen bond term of an HSP value of the solvent B are respectively δd₂, δp₂, and δh₂, and a dispersion term, a polarization term, and a hydrogen bond term of an HSP value of the fine particles C having the surfaces subjected to hydrophobization treatment are respectively δd₃, δp₃, and δh₃ and an interaction radius is R₁, relation of distances between substances is expressed by following Equations (1) and (2),
relation of distances between HSP values of the polyester resin A and the solvent B
$${( {R}_{A - B} )}^{2} = 4 {( δ {d}_{2} - δ {d}_{1} )}^{2} + {( δ {p}_{2} - δ {p}_{1} )}^{2} + {( δ {h}_{2} - δ {h}_{1} )}^{2} \qquad ( 1 )$$
relation of distances between HSP values of the fine particles C having the surfaces subjected to hydrophobization treatment and the solvent B
$${( {R}_{C - B} )}^{2} = 4 {( δ {d}_{2} - δ {d}_{3} )}^{2} + {( δ {p}_{2} - δ {p}_{3} )}^{2} + {( δ {h}_{2} - δ {h}_{3} )}^{2} \qquad ( 2 )$$
at this time, relative energy differences (RED), which are an index representing affinity of the solvent B for the polyester resin A and the fine particles C having the surfaces subjected to hydrophobization treatment, are expressed by Equations (3) and (4), respectively, for example, when a distance R_{A-B} between HSP values of the polyester resin A and the solvent B is equal to a radius of Hansen dissolution sphere of the polyester resin A, (RED)_{AB}=1,
$$relative energy difference {( RED )}_{AB} = ( {R}_{A - B} ) / {R}_{0} \qquad ( 3 )$$
$$relative energy difference {( RED )}_{CB} = ( {R}_{C - B} ) / {R}_{1} \qquad ( 4 )$$
a solvent B having an HSP value present in a range where Formula (5) is satisfied is used as a solvent for the polyester resin A and the fine particles C having surfaces subjected to hydrophobization treatment, the solvent may be a single solvent or a mixed solvent of a plurality of substances:
$$( {R}_{A - B} ) / {R}_{0} \leq 1.5 and ( {R}_{C - B} ) / {R}_{1} \leq 0.75 . \qquad ( 5 )$$

2. The layered film according to claim 1, wherein a coating layer surface has a decane contact angle of 40 degrees or more.

3. The layered film according to claim 1, wherein when an atomic composition ratio is determined in a 10 nm deep region from a coating layer surface by measurement using an X-ray photoelectron spectrometer (ESCA), a ratio of fluorine atoms is 20 at % or more.

4. The layered film according to claim 1, wherein the fine particles C having the surfaces hydrophobized have an average primary particle size of 30 nm to 500 nm.

5. The layered film according to claim 1, wherein the resin substrate film is a polyethylene terephthalate film or a polyethylene naphthalate film.

6. A production method for a layered film including a coating layer containing a polyester resin A and fine particles C having surfaces subjected to hydrophobization treatment on a resin substrate film, wherein the layered film has a haze value of 10% or less and a water sliding angle of 10 degrees or more and less than 70 degrees and a solvent B used during mixing of at least the polyester resin A and the fine particles C having the surfaces subjected to hydrophobization treatment in preparation of a coating liquid for formation of the coating layer satisfies following requirements:
in a case where a dispersion term, a polarization term, and a hydrogen bond term of the polyester resin A are respectively δd₁, δp₁, and δh₁ and an interaction radius is R₀, a dispersion term, a polarization term, and a hydrogen bond term of an HSP value of the solvent B are respectively δd₂, δp₂, and δh₂, and a dispersion term, a polarization term, and a hydrogen bond term of an HSP value of the fine particles C having the surfaces subjected to hydrophobization treatment are respectively δd₃, δp₃, and δh₃ and an interaction radius is R₁, relation of distances between substances is expressed by following Equations (1) and (2),
relation of distances between HSP values of the polyester resin A and the solvent B
$${( {R}_{A - B} )}^{2} = 4 {( δ {d}_{2} - δ {d}_{1} )}^{2} + {( δ {p}_{2} - δ {p}_{1} )}^{2} + {( δ {h}_{2} - δ {h}_{1} )}^{2} \qquad ( 1 )$$
relation of distances between HSP values of the fine particles C having the surfaces subjected to hydrophobization treatment and the solvent B
$${( {R}_{C - B} )}^{2} = 4 {( δ {d}_{2} - δ {d}_{3} )}^{2} + {( δ {p}_{2} - δ {p}_{3} )}^{2} + {( δ {h}_{2} - δ {h}_{3} )}^{2} \qquad ( 2 )$$
at this time, relative energy differences (RED), which are an index representing affinity of the solvent B for the polyester resin A and the fine particles C having the surfaces subjected to hydrophobization treatment, are expressed by Equations (3) and (4), respectively, for example, when a distance R_{A-B} between HSP values of the polyester resin A and the solvent B is equal to a radius of Hansen dissolution sphere of the polyester resin A, (RED)_{AB}=1,
$$relative energy difference {( RED )}_{AB} = ( {R}_{A - B} ) / {R}_{0} \qquad ( 3 )$$
$$relative energy difference {( RED )}_{CB} = ( {R}_{C - B} ) / {R}_{1} \qquad ( 4 )$$
a solvent B having an HSP value present in a range where Formula (5) is satisfied is used as a solvent for the polyester resin A and the fine particles C having surfaces subjected to hydrophobization treatment, the solvent may be a single solvent or a mixed solvent of a plurality of substances:
$$( {R}_{A - B} ) / {R}_{0} \leq 1.5 and ( {R}_{C - B} ) / {R}_{1} \leq 0.75 . \qquad ( 5 )$$

7. The layered film according to claim 1, wherein the fine particles C having the surfaces subjected to hydrophobization treatment is oxide fine particles into which a 1H,1H,2H,2H-perfluoroalkyl group is introduced.

8. The layered film according to claim 1, wherein the fine particles C having the surfaces subjected to hydrophobization treatment is silica fine particles into which a 1H,1H,2H,2H-perfluoroalkyl group is introduced.

9. The layered film according to claim 1, wherein the resin substrate film is a polyethylene terephthalate film.

10. The layered film according to claim 1, wherein the resin substrate film is a polyethylene naphthalate film.

11. The layered film according to claim 3, wherein the ratio of fluorine atoms is 25 at % or more.

12. The layered film according to claim 3, wherein the ratio of fluorine atoms is 30 at % or more.

13. The production method according to claim 6, wherein a coating layer surface has a decane contact angle of 40 degrees or more.

14. The production method according to claim 6, wherein when an atomic composition ratio is determined in a 10 nm deep region from a coating layer surface by measurement using an X-ray photoelectron spectrometer (ESCA), a ratio of fluorine atoms is 20 at % or more.

15. The production method according to claim 6, wherein the fine particles having the surfaces hydrophobized have an average primary particle size of 30 nm to 500 nm.

16. The production method according to claim 6, wherein the resin substrate film is a polyethylene terephthalate film or a polyethylene naphthalate film.

17. The production method according to claim 6, wherein the fine particles C having the surfaces subjected to hydrophobization treatment is oxide fine particles into which a 1H,1H,2H,2H-perfluoroalkyl group is introduced.

18. The production method according to claim 6, wherein the fine particles C having the surfaces subjected to hydrophobization treatment is silica fine particles into which a 1H,1H,2H,2H-perfluoroalkyl group is introduced.

19. The production method according to claim 14, wherein the ratio of fluorine atoms is 25 at % or more.

20. The production method according to claim 14, wherein the ratio of fluorine atoms is 30 at % or more.
